(19) United States
(12) Patent Application Publication
(10) Pub. No.: US 2022/0200302 A1
(43) Pub. Date: Jun. 23, 2022

(54) CONTROL LOGIC TO UPDATE BATTERY CAPACITY

(71) Applicant: Medtronic, Inc., Minneapolis, MN (US)

(72) Inventors: Bo Zhang, Blaine, MN (US); Joel B. Artmann, Elk River, MN (US); Gang Ji, Medina, MN (US)

(21) Appl. No.: 17/528,411

(22) Filed: Nov. 17, 2021

Related U.S. Application Data
(60) Provisional application No. 63/130,346, filed on Dec. 23, 2020.

(51) Int. Cl. H02J 7/00

(52) U.S. Cl. CPC H02J 7/0048; H02J 7/00712; H02J 7/005; H02J 7/0063; H02J 7/0013

(57) ABSTRACT

A method for battery management, the method including determining whether to perform a capacity update of a battery. The method can also include responsive to determining to perform the capacity update, determining existing depth-of-discharge (DoD) of the battery. The method can also include performing a discharge operation or a charge operation based on whether existing DoD is below a threshold. The method can include performing the capacity update subsequent to the discharge or charge operation. Apparatuses and systems for battery management are also described.

### RELATED APPLICATIONS

This application claims the benefit under 35 U.S.C. § 119 of U.S. Provisional Application No. 63/130,346, filed Dec. 23, 2020, which is incorporated herein by reference in its entirety.

### FIELD

The present technology is generally related to techniques for battery management. More specifically, the present technology relates to techniques for accurately determining the true charge state and total capacity of a battery throughout the battery lifetime.

### BACKGROUND

Rechargeable batteries provide power in a wide variety of systems. The full charge capacity of a battery is a measurement of the maximum chemical capacity of a rechargeable battery. As battery cells age, the full charge capacity of the battery generally decreases, and the true charge state of the battery can be difficult to determine with great accuracy. Because measuring and updating the full charge capacity is fundamental to basic battery management, there is a general need to perform this task more accurately through the full life cycle of a battery.

### SUMMARY

The techniques of this disclosure generally relate to methods, systems, and apparatuses for determining total capacity of a battery.

In one aspect, the present disclosure provides a method including determining whether to perform a capacity update of a battery. This can include determining whether a delta in capacity of the battery is above a threshold, and this delta can be based upon chemistry properties of the battery, age of the battery, or other factors. The method can further include responsive to determining to perform the capacity update, determining existing depth-of-discharge (DoD) of the battery. Determining existing DoD can include estimating DoD based on a state of charge of the battery under an open-circuit condition. The method can further include performing a discharge operation or a charge operation based on whether existing DoD is below a threshold. The method can further include performing the capacity update after the discharge operation or the charge operation. Performing the capacity can include detecting a state of charge (SoC) of the battery responsive to determining that battery voltage is stable subsequent the discharge operation or the charge operation. Whether the battery voltage is stable can be based on whether a voltage drop across the battery over a time duration is less than a threshold. The method can also include providing a rest stage for the battery by disconnecting the battery from a load and controlling a bypass switch to power the load directly from a charger.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram of a device that includes a battery management system for managing a battery in accordance with embodiments.

FIG. 2 is a block diagram that illustrates a battery management system in accordance with embodiments.

FIG. 3 is a graph that illustrates a controlled cycle that includes two potential points for capacity update in accordance with embodiments.

FIG. 4 is a flow diagram of a method for battery management in accordance with embodiments.

### DETAILED DESCRIPTION

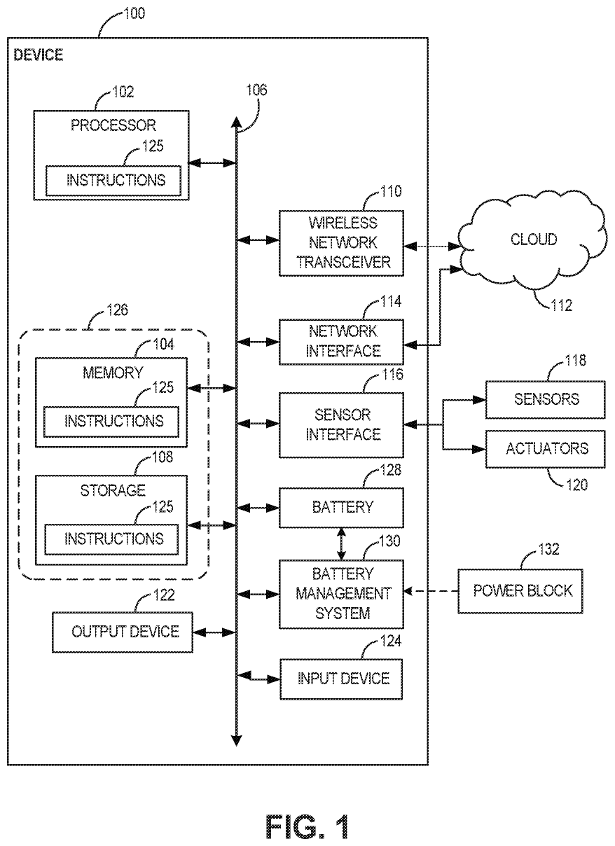

FIG. 1 is a block diagram of a device 100 that includes a battery management system for managing a battery according to operations, processes, methods, and methodologies of embodiments. This device 100 may include any combinations of the hardware or logical components referenced herein. The device 100 can include components of, or be used to control operations of, a ventricular assist device. The device 100 may include or couple with any other device, for example other devices needed for implementation of patient therapies.

The device 100 may include processing circuitry in the form of a processor 102, which may be a microprocessor, a multi-core processor, a multithreaded processor, an ultra-low voltage processor, an embedded processor, or other known processing elements. The processor 102 may be a part of a system on a chip in which the processor 102 and other components described herein are formed into a single integrated circuit.

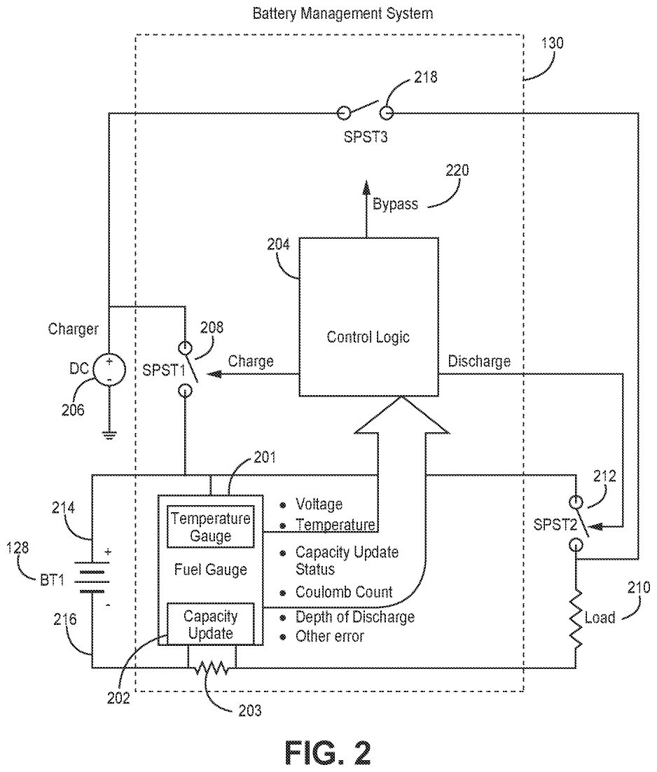

A battery 128 may power the device 100, although, in examples in which the device 100 is in a fixed location, the device 100 may have a power supply coupled to an electrical grid. The battery 128 may be a lithium-ion battery although embodiments are not limited thereto. A battery management system 130 may be included in the device 100 or the battery management system 130 may be part of an external device coupled to the device 100 to track the state of charge (SoC) of the battery 128. A power block 132, or other power supply coupled to a grid, may be coupled with the battery management system 130 to charge the battery 128. In some examples, the power block 132 may be replaced with a wireless power receiver to obtain the power wirelessly. Further detail regarding the battery management system 130 is provided below with reference to FIG. 2.

FIG. 2 is a block diagram that illustrates the battery management system 130 in accordance with embodiments. The battery management system 130 may be used to monitor other parameters of the battery 128 to provide failure predictions, such as the state of health (SoH) and the state of function (SoF) of the battery 128. The battery management system 130 may include battery monitoring circuitry, for example fuel gauge 202.

The battery management system 130 may include control logic 204. In embodiments control logic 204 is executed on the processor 102 (FIG. 1) of the device 100, although embodiments are not limited thereto. For example, in some embodiments, the battery management system 130 can include processing circuitry for execution of at least some operations included in control logic 204.

The control logic 204 can control a charging cycle of the battery 128 by controlling charger 206 when switch element 208 is closed in a controlled manner as described later herein. The control logic 204 can also control a discharge cycle of the battery 128 by switching a load 210 to draw current from the battery 128 when switch element 212 is closed in a controlled fashion as described later herein. In example embodiments, the load 210 includes, or can model, ventricular assist device (not shown). The fuel gauge 202 measures the amount of charge remaining in the battery 128 and provides indicators thereof to the control logic 204 as described later herein.

A bypass switch 218 and bypass path 220 are placed between charger 206 and the load 210. The bypass path 220 is used to power the load 210 directly by the charger 206 to allow the battery 128 to rest by disconnecting from the load 210 and charger 206. In this case, the bypass switch 218 is closed and both switch 208 and 212 are open. When the battery is discharging, the load switch 212 is closed and both bypass switch and charging switch 208 are open. When the battery 128 is charging, the load switch 212 is open and both bypass switch 218 and charging switch 208 are closed.

Battery 128 capacity corresponds to the quantity of electric charge that can be accumulated during battery 128 charging, stored in open circuit conditions, and released during battery 128 discharge. When the battery 128 is discharged with constant current (e.g., during a discharge cycle according to methods described herein, or during normal operations of the device 100), battery 128 capacity is given by the formula C_{d}=I·t_{d}, where t_{d} is the discharge duration, and I is current. When discharge duration is expressed in hours, the typical unit for battery 128 capacity is the Ampere-hour (AH).

SoC of the battery 128 indicates voltage at the terminals 214, 216 of that battery 128 when the battery 128 is at rest, or in equilibrium. The mathematical relationship between SoC and equilibrium voltage is a known relationship and is based on battery type. When the battery 128 is not in equilibrium, current is flowing through the battery 128. In this situation, the actual voltage at the terminals 214, 216 of the battery 128 is lower than the equilibrium voltage by an amount that can be calculated using Ohm's Law knowing internal resistance of the battery 128.

Ohm's Law is applied to operation of some fuel gauges such as the fuel gauge 202. The fuel gauge 202 can use Ohm's Law by measuring or the internal resistance of the battery 128 being monitored, multiplying this internal resistance by a measured current to determine an intermediate voltage value at 203, and then offsetting the measured terminal voltage by the intermediate voltage value to obtain an estimate of the equilibrium voltage of the battery 128. Available battery 128 capacity can then be calculated using this estimate of the equilibrium voltage. Other elements and algorithms can be added to improve accuracy of the fuel gauge 202, including Coulomb counters and other apparatuses. The fuel gauge 202 can provide capacity information, voltage information, temperature information, capacity update status, Coulomb count, depth of discharge, error messages, and other information to other systems (e.g., control logic 204).

However, methods for estimating equilibrium voltage are subject to errors, especially as the age of the battery 128 increases. Furthermore, as the battery 128 ages, the total capacity of the battery 128 fades. Without adequately tracking the total capacity of the battery 128, the estimate of the SoC and remaining capacity of the battery 128 will become less accurate.

To remedy these and other problems, control logic 204 provides a controlled charging cycle to achieve a successful capacity update. Successful capacity updates rely on a minimum capacity change, because if capacity change is below a threshold, the capacity change can be difficult to detect as the capacity change becomes indistinguishable from noise. Capacity change needs to meet or exceed a threshold to become large enough to be measured. Successful capacity updates can also depend on stability of open-circuit-voltage (OCV), temperature, depth of discharge (DoD) and other conditions. All these conditions, and other conditions, can be controlled by charge and discharge cycles that are controlled in accordance with embodiments.

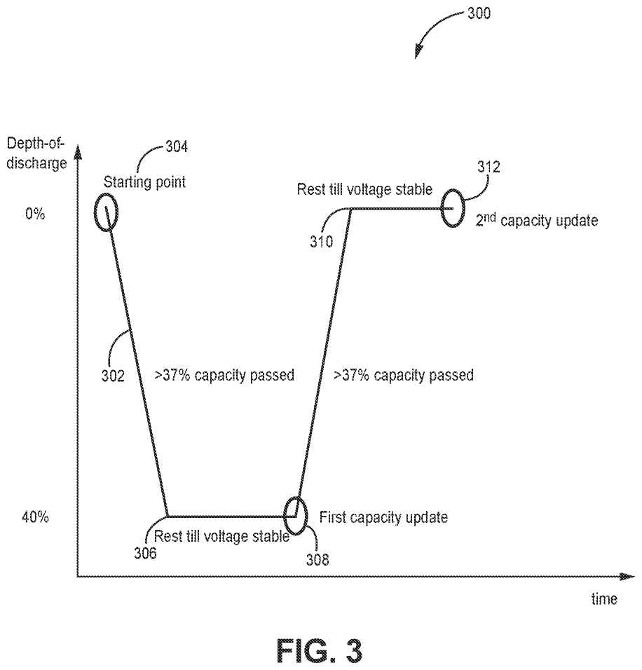

FIG. 3 is a graph 300 that illustrates a controlled cycle 302 that includes two potential points for capacity update in accordance with embodiments. Reference is made to elements of the device 100 (FIG. 1) and the battery management system 130 (FIG. 2). After the battery 128 is fully charged and rested, indicated as 0% depth-of-discharge at point 304, the control logic 204 controls the discharge the battery 128 to 40% DoD at point 306. Other values for DoD can be used; however, a sufficiently deep discharge must be performed to accurately measure battery 128 capacity. The DoD used can be chemistry-dependent, such that discharging less than DoD 40% can lead to less total voltage drop from point 304 to point 308, and therefore the noise on the voltage measurement remains the same. The error in voltage measurement can be according to Equation 1:

% error=noise/total voltage drop (1)

In other words, increasing noise and decreasing voltage drop can each lead to an increase in error in voltage measurement. DoD can be estimated based on a SoC of the battery 128. At point 306, the control logic 204 will disconnect the battery 128 from the load 210 and power the load 210 directly from the charger 206 through the bypass switch 218 and bypass path 220. The battery 128 will rest until the battery 128 voltage is stable at point 308. After the battery 128 voltage is stable, the fuel gauge 202 may update battery 128 capacity by detecting SoC of the battery 128 and determining the amount of capacity remaining in the battery 128 by dividing the discharged capacity Q_{dsg} by the change in SoC (SoCₛₜₐᵣₜ−SoC_{end}) according to Equation (2):

$$Capacity = \frac{{Q}_{d s g}}{S o {C}_{s t a r t} - S o {C}_{e n d}} \qquad ( 2 )$$

Then, the control logic 204 controls the switching element 208 and charger 206 to charge the battery 128 to 0% DoD and the battery 128 can rest at point 310. At point 312, the battery 128 has been at rest until the battery 128 voltage is stable, at which point the fuel gauge 202 may perform a second capacity update.

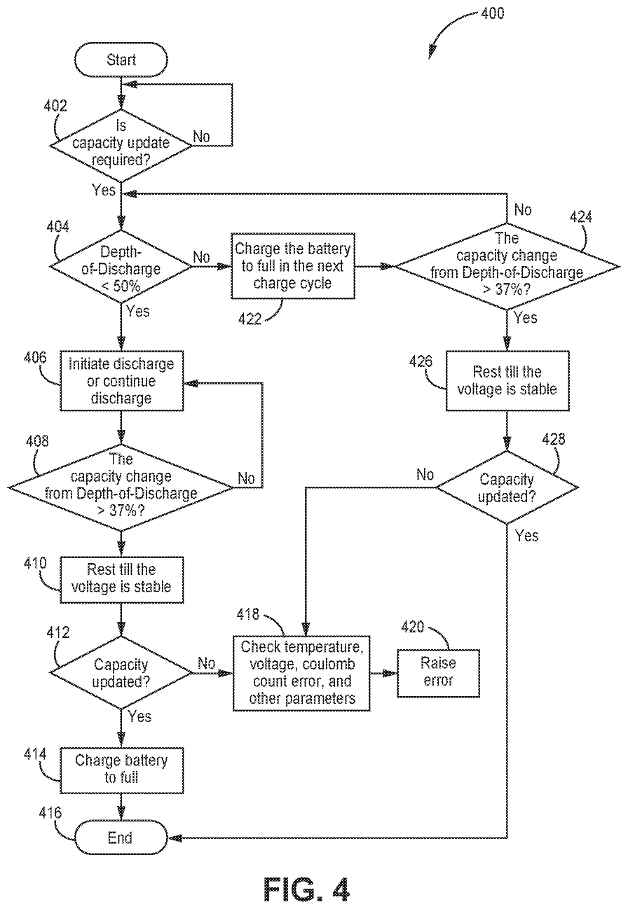

FIG. 4 is a flow diagram of a method 400 for battery management in accordance with embodiments. The method 400 can be implemented by circuitry (e.g., control logic 204 (FIG. 2)) executing on a processor 102, fuel gauge 202 circuitry (FIG. 2), or battery management system 130 (FIG. 1).

At operation 402, control logic 204 determines whether to perform a capacity update of a battery (e.g., the battery 128 (FIG. 1 and FIG. 2). Capacity updates can be required if a capacity fade is expected to be sufficiently large (e.g., a delta in capacity is above a threshold). In some examples, the delta can be based upon chemistry of the battery, battery age, time idle, time in use, and other factors. In some examples, capacity fade will be sufficiently large after an amount of time has elapsed that is likely to result in reduced capacity based on battery chemistry, historical data provided by the manufacturer, or other data. In some examples, the number of months can be about three months. If no capacity update is required, processor 102 periodically checks whether a capacity update is required and takes no further action until such an update is required.

At operation 404, if a capacity update is required, the processor 102 shall check the DoD. If the DoD is lower than a certain percentage (in some examples, 50% DoD, although embodiments are not limited thereto), the processor 102 will control the battery 128 to discharge at point 306 until the capacity drop is higher than a threshold DoD (in some examples 37%, although embodiments are not limited thereto), while the control logic 204 performs periodic checking for such a level of DoD in operation 408. The control logic 204 will disconnect the battery 128 from the load 210 by opening switch 212 and letting the charger 206 directly power the load 210 by closing the bypass switch 218. The battery 128 will rest until the voltage is stable in operation 410. For example, if the average measured voltage drops less than a threshold over a duration of time (e.g., if the voltage drops at a rate less than about 200 μVolts per minute), the voltage may be considered stable. In operation 412, if the capacity has been updated (for example if the fuel gauge 202 provides an indication to the control logic 204 that the capacity has been updated by, for example, setting a flag or providing another message), the control logic 204 will control the switch 208 and charger 206 to charge the battery 128 to a fully charged state in operation 414. At operation 416 the routine is completed with successful capacity update. However, if the capacity update does not occur, as determined at operation 412, then the control logic 204 shall evaluate parameter such as temperature, voltage, coulomb count error, and other parameters using, for example, dedicated temperature gauges 201, voltage meter 203, embedded coulomb counters, and other circuitry not shown in FIG. 2. Upon detecting any error or anomaly in these or other parameters, the control logic 204 will generate an error message to the output device 122 or to an error handling routine in processor 102.

Referring again to operation 404 above, if the existing depth-of-discharge is not lower than 50%, the battery 128 might not have enough energy to complete a required discharge step. Therefore, the control logic 204 will control the switch 208 and charger 206 to charge the battery to a fully charged state in operation 422. After this charging operation 422, if the capacity increase is determined to be higher than 37% of DoD by the control logic 204, in operation 424, the control logic 204 may disconnect the battery 128 from the charger 206 and the load 210 by opening switch 208 and switch 212. The battery 128 will rest until the voltage is stable in operation 426. If the capacity is updated at this point, as determined at operation 428, the method 400 may end with a successful capacity update at operation 416. Otherwise, if the capacity update does not occur, error conditions are determined and indicated similarly to operation 418 as described earlier herein. If the result of operation 424 is a determination that the capacity increase is not higher than 37% DoD, then method 400 resumes at operation 404 described earlier herein to keep charging the battery 128.

Referring again to FIG. 1, other components that can be included in the device 100 are described. The processor 102 may communicate with a system memory 104 over an interconnect 106 (e.g., a bus). Any number of memory devices may be used to provide for a given amount of system memory. As examples, the memory 104 may be random access memory (RAM). However, any other type of memory can be included. Persistent storage can also be provided by storage 108. Storage 108 may also couple to the processor 102 via the interconnect 106. Storage 108 may include disk drives, flash memory cards, Universal Serial Bus (USB) flash drives, etc.

The components may communicate over the interconnect 106. The interconnect 106 may include any number of technologies, including industry standard architecture (ISA), extended ISA (EISA), peripheral component interconnect (PCI), peripheral component interconnect extended (PCIx), PCI express (PCIe), or any number of other technologies. The interconnect 106 may be a proprietary bus.

The interconnect 106 may couple the processor 102 to a transceiver 110. The transceiver 110 may use any number of frequencies and protocols, IEEE, or Bluetooth protocols, although embodiments are not limited to these protocols. The transceiver 110 may be included to communicate with devices or services in the cloud 112 via local or wide area network protocols.

A network interface controller (NIC) 114 may be included to provide a wired communication to other devices or systems through the cloud 112. The wired communication may provide an Ethernet connection or may be based on other types of networks. The interconnect 106 may couple the processor 102 to a sensor interface 116 that is used to connect additional devices or subsystems. These additional devices may include sensors 118, such as optical light sensors, camera sensors, temperature sensors, and the like. The interface 116 further may be used to connect the device 100 to actuators 120, such as power switches, valve actuators, an audible sound generator, a visual warning device, and the like.

In some optional examples, various input/output (I/O) devices may be present within or connected to, the device 100. For example, a display or other output device 122 may be included to show information, such as sensor readings, fuel gauge readings, fuel gauge diagnostic outputs, etc. An input device 124, such as a button, touch screen or keypad may be included to accept input. An output device 122 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the device 100. A display or console hardware, in the context of the present system, may be used to provide output and receive input of a medical device, including an implantable medical device; to identify a state of a medical device or related/connected devices; or to conduct any other number of management or administration functions.

The storage 108 may include instructions 125 in the form of software, firmware, or hardware commands to implement the techniques described herein. Although such instructions 125 are shown as code blocks included in the memory 104 and the storage 108, it may be understood that any of the code blocks may be replaced with hardwired circuits, for example, built into an application specific integrated circuit (ASIC).

In an example, the instructions 125 provided via the memory 104, the storage 108, or the processor 102 may be embodied as a non-transitory, machine-readable medium 126 including code to direct the processor 102 to perform electronic operations in the device 100. The processor 102 may access the non-transitory, machine-readable medium 126 over the interconnect 106. For instance, the non-transitory, machine-readable medium 126 may be embodied by devices described for the storage 108 or may include specific storage units such as optical disks, flash drives, or any number of other hardware devices. The non-transitory, machine-readable medium 126 may include instructions to direct the processor 102 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that can store, encoding or carrying instructions for execution by a machine and that cause the machine to perform any one or more of the methodologies of the present disclosure or that can store, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of several transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically, or statically linking), encoding, decoding, encrypting, unencrypting, packaging, unpackaging, or otherwise manipulating the information into the instructions.

Various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A method comprising:
determining whether to perform a capacity update of a battery;
responsive to determining to perform the capacity update, determining existing depth-of-discharge (DoD) of the battery;
performing a discharge operation or a charge operation based on whether existing DoD is below a threshold; and
performing the capacity update subsequent to the discharge operation or the charge operation.

2. The method of claim 1, wherein determining whether to perform a capacity update of the battery includes determining whether a delta in capacity of the battery is above a threshold.

3. The method of claim 2, wherein the delta is based upon chemistry properties of the battery.

4. The method of claim 3, wherein the delta is based upon age of the battery.

5. The method of claim 1, wherein performing the capacity update comprises detecting a state of charge (SoC) of the battery responsive to determining that battery voltage is stable subsequent the discharge operation or the charge operation.

6. The method of claim 5, wherein determining that battery voltage is stable comprises determining that a voltage drop over a time duration is less than a threshold.

7. The method of claim 1, wherein determining existing DoD comprises estimating DoD based on a state of charge of the battery under an open-circuit condition.

8. The method of claim 1, further comprising:
responsive detecting that the capacity update was not successfully performed, detecting a value of at least one parameter of the battery; and
providing the value to a control device.

9. The method of claim 8, wherein the at least one parameter includes at least one of temperature and coulomb count.

10. The method of claim 1, further comprising:
providing a rest stage for the battery by disconnecting the battery from a load and controlling a bypass switch to power the load directly from a charger.

11. A battery charging apparatus comprising:
a charger to charge one or more batteries;
a bypass path to provide power between the charger and a load; and
a computing apparatus comprising one or more processors operably coupled to the charger and configured to:
determine whether to perform a capacity update of the one or more batteries;
responsive to determining to perform the capacity update, determine existing depth-of-discharge (DoD) of the one or more batteries;
perform a discharge operation or a charge operation based on whether existing DoD is below a threshold; and
perform the capacity update subsequent to the discharge operation or the charge operation.

12. The battery charging apparatus of claim 11, wherein the one or more processors are configured to perform the capacity update of the one or more batteries by determining whether a delta in capacity of the one or more batteries is above a threshold.

13. The battery charging apparatus of claim 11, wherein the one or more processors are configured to perform the capacity update of the one or more batteries by detecting a state of charge (SoC) of the one or more batteries responsive to determining that battery voltage is stable subsequent the discharge operation or the charge operation.

14. The battery charging apparatus of claim 11, wherein the one or more processors are configured to determine existing DoD by estimating DoD based on a state of charge of the one or more batteries under an open-circuit condition.

15. The battery charging apparatus of claim 11, wherein the one or more processors are configured to control the one or more batteries to enter a rest state, and to control the bypass path to charger to provide power to the one or more batteries through the charger during the rest state.

16. A system comprising:
a charging apparatus for charging one or more batteries;
a bypass path to provide power between the charging apparatus and a load; and
a battery operatively coupled to the charging apparatus, the battery comprising:
one or more electrochemical cells; and
a battery management system comprising one or more processors operably coupled to the one or more electrochemical cells and configured to:
determine whether to perform a capacity update of the one or more batteries;
responsive to determining to perform the capacity update, determine existing depth-of-discharge (DoD) of the one or more batteries;
perform a discharge operation or a charge operation based on whether existing DoD is below a threshold; and
perform the capacity update subsequent to the discharge operation or the charge operation.

17. The system of claim 16, wherein the battery management system is configured to perform the capacity update of the one or more batteries by determining whether a delta in capacity of the one or more batteries is above a threshold.

18. The system of claim 16, wherein the battery management system is configured to perform the capacity update of the one or more batteries by detecting a state of charge (SoC) of the one or more batteries responsive to determining that battery voltage is stable subsequent the discharge operation or the charge operation.

19. The system of claim 16, wherein the battery management system is configured to determine existing DoD by estimating DoD based on a state of charge of the one or more batteries under an open-circuit condition.

20. The system of claim 16, wherein the battery management system is configured to control the one or more batteries to enter a rest state, and to control the bypass path to the charging apparatus to provide power to the one or more batteries through the charging apparatus during the rest state.
